(19) United States
(12) Patent Application Publication
(10) Pub. No.: US 2026/0178378 A1
(43) Pub. Date: Jun. 25, 2026

(54) PREDICATED MULTI-PATH JOB SUBMISSION ACROSS GPU ENGINES FOR OPTIMAL LOAD BALANCING AND PERFORMANCE ACROSS GPU ENGINES

(71) Applicant: ATI Technologies ULC, Markham (CA)

(72) Inventors: Sonu Thomas, London (CA); Jason Francis McCarty, Markham (CA)

(21) Appl. No.: 18/989,482

(22) Filed: Dec. 20, 2024

(51) Int. Cl. G06F 9/48; G06F 9/38

(52) U.S. Cl. CPC G06F 9/4881; G06F 9/3814; G06F 9/4856

(57) ABSTRACT

An apparatus and method for efficiently scheduling instructions for a parallel data processing circuit. In various implementations, a computing system includes a variety of types of processing circuits with two or more capable of executing a same type of task. A hardware component, such as a processing circuit, accesses a command buffer. The processing circuit reads, in the command buffer, a predicate command corresponding to the next task to execute. The processing circuit checks the predicate memory location corresponding to the next task to verify whether another hardware component has started the next task. If any other hardware component has begun executing the task, then the processing circuit discards the task from its command buffer. Otherwise, if no other hardware component has begun executing the task, then the processing circuit updates the predicate memory location corresponding to the task to specify the task has begun execution.

### BACKGROUND

### Description of the Relevant Art

The parallelization of tasks is used to increase the throughput of computing systems. To this end, compilers extract parallelized tasks from applications to execute in parallel on the system hardware. Parallel data processing circuits execute multiple threads simultaneously in order to take advantage of the identified instruction-level parallelism. For example, the parallel data processing circuit includes multiple parallel lanes of execution, such as single instruction multiple data (SIMD) micro-architecture or other. These types of micro-architectures provide higher instruction throughput for parallel data applications than a general-purpose micro-architecture. Software development kits (SDKs) and application programming interfaces (APIs) were developed for use with widely available high-level languages to provide supported function calls. The function calls provide an abstract layer of the parallel implementation details of the variety of types of parallel data processing circuits. The details are hardware specific to the parallel data processing circuits but hidden to the developer to allow for more flexible writing of software applications. The tasks benefiting from parallel data execution come from at least scientific, entertainment, medical and business (finance) applications.

The functionality of computing systems increases with the support of large amounts of input data being sent to a variety of types of processing circuits. Although processing circuits can be different and include different microarchitectures, two or more of the processing circuits can perform the same type of task. However, most scheduling techniques rely on load balancing or selecting upfront a processing circuit based on performance although the selected processing circuit is busy while another processing circuit is available to execute the outstanding job.

In view of the above, methods and apparatuses for performing efficient scheduling of tasks across a variety of processing circuits are desired.

### BRIEF DESCRIPTION OF THE DRAWINGS

FIG. 1 is a generalized diagram of a computing system layering model that performs efficient scheduling of tasks across a variety of processing circuits.

FIG. 2 is a generalized diagram of command buffers that support efficient scheduling of tasks across a variety of processing circuits.

FIG. 3 is a generalized diagram of a computing system that performs efficient scheduling of tasks across a variety of processing circuits.

FIG. 4 is a generalized diagram of a method for efficiently scheduling tasks across a variety of processing circuits.

FIG. 5 is a generalized diagram of a method for efficiently scheduling tasks across a variety of processing circuits.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently scheduling tasks across a variety of types of processing circuits are disclosed. In various implementations, a computing system includes a variety of types of processing circuits with two or more capable of executing the same type of task. As used herein, a “function” can also be referred to as a “task” or a “job” that includes a sequence of instructions or commands that provide one or more output results based on input data. Examples of functions (tasks) are a process or a thread of an application. As used herein, a “functionality group” includes two or more processing circuits with each processing circuit capable of executing a particular function and with at least one processing circuit using a different microarchitecture from other processing circuits of the two or more processing circuits in the same functionality group. The processing circuits have the same task assigned to them by having the same task written to their corresponding command buffers. Only one of the processing circuits executes the task based on executing a predicate command used to notify the other processing circuits when the task has begun.

Typically, a computing system schedules the task to a single one of the processing circuits based on the type of function, predicted performance, a priority level, or other criteria. However, such scheduling to a single processing circuit can cause a delay in starting the task while other processing circuits capable of executing the task become available. In contrast, the proposed solution schedules the task to multiple processing circuits, rather than a single processing circuit. These processing circuits are grouped into a functionality group. A hardware component, such as a processing circuit, accesses a command buffer. The processing circuit reads, in the command buffer, a predicate command corresponding to the next task to execute. The predicate command includes an address pointing to a predicate memory location. The predicate command determines whether the predicate memory location stores data indicating the corresponding task has already begun execution. Therefore, the predicate command returns at least a true or false result indicating whether the corresponding task has already begun execution. The predicate memory location is a data storage location accessible by multiple processing circuits. In other words, the predicate memory location is a shareable memory location.

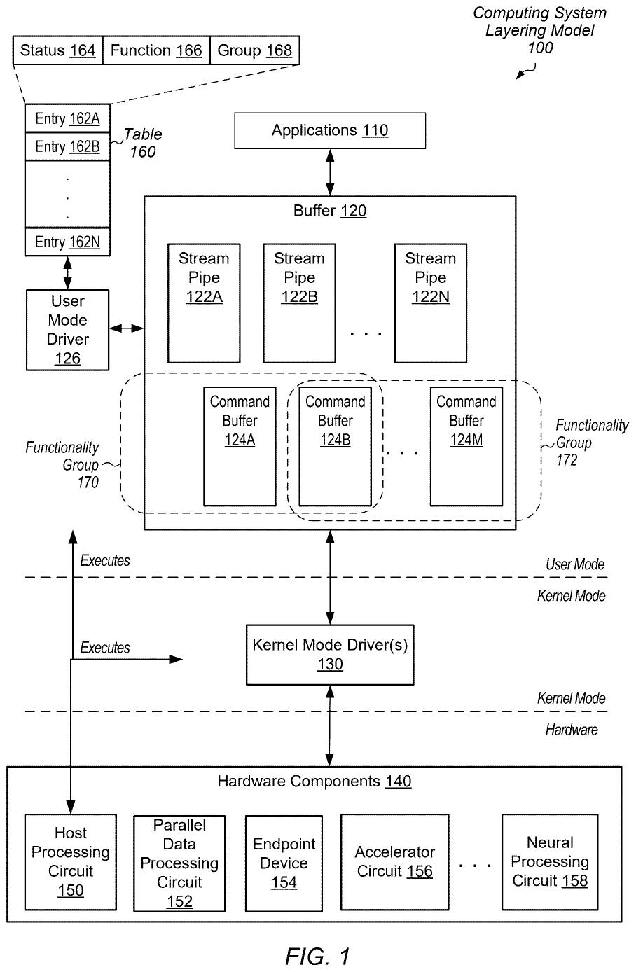

The processing circuit checks the predicate memory location to verify whether another processing circuit has started the corresponding task. When any processing circuit has begun executing the task, that processing circuit had already updated the predicate memory location to store an indication specifying that execution of the task has begun. If any other hardware component has begun executing the task, then the processing circuit discards both the predicate command and the commands of the task from its command buffer. Otherwise, if no other hardware component has begun executing the task, then the processing circuit updates the predicate memory location corresponding to the task to specify the task has begun execution. The processing circuit accesses the commands of the task to begin execution. Further details of these techniques for efficiently scheduling tasks across a variety of processing circuits are provided in the following description of FIGS. 1-5.

Turning now to FIG. 1, a generalized diagram is shown of a software and hardware layering model 100 that supports efficient scheduling of tasks across a variety of processing circuits. As shown, software and hardware layering model 100 (or model 100) uses a collection of user mode components, kernel mode components and hardware. In various implementations, the user mode components and kernel mode components are executed by host processing circuit 150 of hardware components 140. A layered driver model, such as model 100, is one manner to process the application 110 and input/output (I/O) requests. In this model, each driver or other component is responsible for processing a part of a request or processing data stored in buffer 120. If the request cannot be completed, information for the lower driver in the stack is set up and the request is passed along to that driver. Such a layered driver model allows functionality to be dynamically added to a driver stack. It also allows each driver to specialize in a particular type of function and decouples it from having to know about other drivers.

In various implementations, application 110 is a computer program written by a developer in one of a variety of high-level programming languages such as C, C++, and Java and so on. Application 110 begins being processed on host processing circuit 150 of hardware components 140. In various implementations, host processing circuit 150 is a general-purpose processing unit such as a central processing unit (CPU) or other type of host processing circuit. A library uses the user mode driver (UMD) 126 to translate instructions of function calls in the application 110 to commands that are particular to a piece of hardware such as one of the hardware components 140. The library can also use the user mode driver 126 to send the translated commands to the kernel mode driver 130.

As used herein, a “function” can also be referred to as a “task” or a “job” that includes a sequence of instructions or commands that provide one or more output results based on input data. Examples of functions (tasks) are a process or a thread of an application, a function call, a straight-line sequence of instructions of a basic block, and so forth. A function (task or job) typically includes its own context information should the function need to stop and resume execution later. The context information includes state information stored in control registers and a memory stack of the corresponding processing circuit executing the function (task). Examples of the context information are an instruction program counter value, contents of a memory stack, a stack pointer, a unique identifier of the function (task), identifiers of files or devices accessed by the function, currently used operating parameters (e.g., power supply voltage and operating clock frequency) or operating state/mode (e.g., active, idle, blocked, ready), data access permissions, history usage information corresponding to the processing circuit executing the function (task), and so forth.

The computer program (application 110) in the chosen higher-level language is partially processed with the aid of libraries with their own application program interfaces (APIs). For video graphics applications, platforms such as DirectX, OpenCL (Open Computing Language), OpenGL (Open Graphics Library) and OpenGL for Embedded Systems (OpenGL ES), are used for running programs on parallel data processing circuits, such as graphics processing units (GPUs), from AMD, Inc. For audio processing applications, platforms such as WASAPI, Media Foundation, XAudio2, and Audio Graph are used for running programs on parallel data processing circuits. In some implementations, the translated commands are sent to the kernel mode driver 130 via an input/output (I/O) driver (not shown). In one implementation, the I/O control system call interface is used. In various implementations, multiple drivers exist in a stack of drivers between the application 110 and a piece of hardware of hardware components 140 for processing a request.

A file system driver (not shown) or other driver provides a means for the application 110 to send information, such as the translated commands, to storage media such as buffer 120, system memory, or other. The stream pipes 122A-122N store commands of processes of the application. These commands and other accompanying information are later stored in two or more of the command buffers 124A-124M, rather than in only one of the command buffers 124A-124M. Typically, commands and jobs are assigned to a single one of the command buffers 124A-124M associated with one of the hardware components 140, but here, the jobs are assigned to multiple command buffers of the command buffers 124A-124M with a predicate command preceding the job. These requests are dispatched to the file system driver via the I/O manager or the kernel mode driver 130.

In various implementations, user mode driver 126 accesses table 160 when scheduling command groups to hardware components 140. Entries 162A-162N of table 160 are implemented by a data structure that utilizes one of flip-flop circuits, a random-access memory (RAM), a content addressable memory (CAM), or otherwise. Although particular information is shown as being stored in the fields 164-168 of entries 162A-162N, and in a particular contiguous order, in other implementations, a different order is used, and a different number and type of information is stored. As shown, field 164 stores status information such as at least a valid bit indicating valid information is stored in an allocated entry. Field 166 stores an identifier or other indication specifying a function. Field 168 stores an identifier or other indication specifying a functionality group. As shown, command buffers 124A-124M are partitioned into functionality groups such as functionality groups 170 and 172.

As used herein, a “functionality group” includes two or more processing circuits with each processing circuit capable of executing a particular function and with at least one processing circuit using a different microarchitecture from other processing circuits of the two or more processing circuits in the same functionality group. For example, each of a field programmable gate array (FPGA), such as accelerator circuit 156, a graphics processing unit (GPU) or graphics processing circuit, such as parallel data processing circuit 152, and neural processing unit (NPU) or neural processing circuit 158 can perform inference by executing processes of machine learning (ML) stages or layers of a trained ML model and each uses a different microarchitecture. Each of processing circuits 152, 156 and 158 can provide the same functionality by executing a particular function (task or job), and accordingly, can be placed in functionality group 170. One or more of entries 162A-162N of table 160 can store a function identifier (ID) of a process of a ML stage or layer and an identifier of functionality group 170. Rather than insert a command group of a process (function or task) of a ML layer in a single one of command buffers 124A-124M, user mode driver 125 inserts copies of the command group in multiple command buffers of command buffers 124A-124M based on results of a table lookup operation performed on table 160. Other examples of a function that can be executed by multiple processing circuits with different microarchitectures from one another include video graphics color correction, data compression and decompression (codec), video graphics scaling, and so on.

The command groups are a set of commands to be sent and processed atomically. The kernel mode driver 130 sends the command group commands to a particular component of hardware components 140. In various implementations, by accessing table 160, the user mode driver 126 sends translated commands of a process or thread (function or task) to two or more of command buffers 124A-124M corresponding to two or more components of hardware components 140. Locking primitives and semaphores are not used. Performance comparisons between components of hardware components 140 are not used. Load balancing techniques are not used. Rather, the user mode driver 126 of the driver stack (or other scheduler) prepares multiple command buffers, such as command buffers 124A-124M, targeting different types of processing circuits and other components of hardware components 140 that provide similar functionality such as multiple hardware components of a same functionality group.

To prevent corruption when inserting copies of a command group in two or more of the command buffers 124A-124M, layering model 100 uses predication support. When executed by host processing circuit 150, the user mode driver 126 or other drivers of the driver stack prepare the multiple command buffers, such as command buffers 124A-124M, for the same job preceded by a corresponding predication command. After submission (assignment of the job), each of the command buffers (command buffers 124A-124M) waits for its turn managed by the operating system (OS) scheduler. When a given hardware component of the hardware components 140 receives the job through its corresponding command buffer (one of command buffers 124A-124M), the given hardware component executes the corresponding predication (or predicate) command. Based on executing its preceding predication command, the given hardware component checks whether another processing circuit of hardware components 140 has already begun execution of the job. To do so, the given hardware component checks a predicate memory location located by an address or other pointer of the predicate command.

The predicate memory location is a data storage location accessible by multiple processing circuits. In other words, the predicate memory location is a shareable memory location. When any processing circuit has begun executing the task, that processing circuit had already updated the predicate memory location to store an indication specifying that execution of the task has begun. In an implementation, the shareable predicate memory location stores a single bit that specifies whether a corresponding task (job) has already begun. In another implementation, the predicate memory location stores two bits specifying whether the job (task) has begun and whether the job (task) has completed. In yet another implementation, the predicate memory location also stores an identifier of the processing circuit that has already begun execution of the job. The predicate memory location can also store statistics such as a timer value of how long the job (task) has been running. A variety of other types of information can be stored in the predicate memory location based on design requirements.

When the information stored in the predicate memory location specifies no other hardware component has begun executing the job, the given hardware component updates this information to specify that the given hardware component has begun executing the job. At a later time when another hardware component executes its corresponding predicate command, this other hardware component will read the updated information in the shareable predicate memory location, determine the given hardware component has already begun execution of the job, and then discard both the predicate command and commands of the job from its command buffer of command buffers 124A-124M.

Hardware components 140 includes a variety of types of hardware. In some implementations, hardware components 140 includes at least a host processing circuit 150, parallel data processing circuit 152, endpoint device 154, accelerator circuit 156 and neural processing circuit 158. Other types of hardware components, which are not shown but can be included in hardware components 140 include memory controllers, a variety of types of peripheral devices, audio and/or video processing circuits, and so forth. In some implementations, host processing circuit 150 is a general-purpose processing circuit, such as a central processing unit (CPU), and includes multiple general-purpose processor cores, each with one or more general-purpose pipelines that execute instructions of a particular instruction set architecture (ISA). Parallel data processing circuit 152 can be a GPU, a digital signal processor (DSP), or other. Endpoint device 154 can be a peripheral device such as a microphone or a speaker. Accelerator circuit 156 can be a processing circuit that executes a variety of types of machine learning (ML) models such as transformer stages, large language models, diffusion models, and so forth. an audio digital signal processor (DSP) or digital signal processing circuit. Similarly, neural processing circuit 158 is an embedded neural processing unit (NPU) or an embedded neural processing circuit. Neural processing circuit 158 can also be an embedded inference processing unit (EIPU) or an embedded inference processing circuit.

In various implementations, host processing circuit 150 obtains available features of the hardware components 140 during a discovery stage of a boot process or operation. When executing the user mode driver 126 or another scheduler, host processing circuit 150 receives indications, based on the boot operation or process, specifying available features provided by the hardware components 140. Additionally, when peripheral devices are added (plug-in operation), such as an additional display device with a display controller or an on-board display controller becomes active due to the connection, the available features of the hardware components 140 are updated. Based on these indications, the scheduler can form functionality groups, such as functionality groups 170 and 172, of hardware components that can execute the same job. The scheduler can also update table 160. Therefore, later, the scheduler can send jobs to multiple command buffers (two or more of command buffers 124A-124N).

When executing user mode driver 126, host processing circuit 150 accesses one of the stream pipes 122A-122N that stores the data corresponding to the currently executed process. Processing circuit 150 accesses, from the corresponding one of the stream pipes 122A-122N, a task with an indication specifying a task type. When executing the user mode driver 126 or scheduler 128, based on the task type, host processing circuit 150 sends jobs to the associated two or more command buffers (two or more of command buffers 124A-124N).

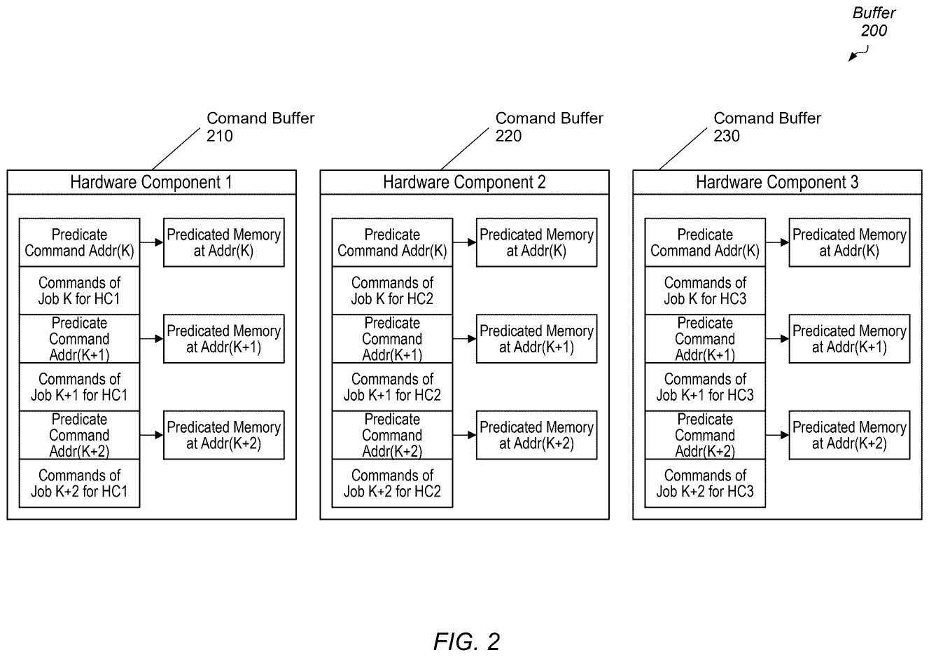

Referring to FIG. 2, a generalized diagram is shown of buffer 200 that supports efficient scheduling of tasks across a variety of processing circuits. As shown, buffer 200 includes command buffers 210, 220 and 230. In various implementations, buffer 200 is a functionality group buffer. Although three command buffers are shown, another number of command buffers are used in other implementations based on design requirements. Each command buffer of command buffers 210-230 includes entries for commands of a job or task such as a thread or a process of an application. In various implementations, each of the command buffers 210-230 corresponds to a different type of processing circuit although the different types of processing circuits are capable of executing the same type of task. In an implementation, a display controller uses command buffer 210, and a video processing circuit, such as a GPU or dedicated video processor, has a different microarchitecture and uses command buffer 220. A general-purpose host processing circuit has another different microarchitecture and uses command buffer 230. Each of the display controller, the video processing circuit, and the host processing circuit are grouped into a functionality group corresponding to a color correction task. In an implementation, each of the display controller, the video processing circuit, and the host processing circuit are grouped into functionality group 172 (of FIG. 1).

In various implementations, when executed by the host processing circuit, the scheduler inserts the same job, such as a color correction job, in each of command buffers 210-230. For example, the scheduler inserts “Commands of Job K for HC1” in command buffer 210, “Commands of Job K for HC2” in command buffer 220, and “Commands of Job K for HC3” in command buffer 230. Here, “HC1” refers to Hardware Component 1, “HC2” refers to Hardware Component 2, and “HC3” refers to Hardware Component 3. Therefore, the “Commands of Job K for HC1” perform the same task, such as color correction, as “Commands of Job K for HC2,” but the commands can be different due to the commands of “Commands of Job K for HC1” being specific to the hardware and microarchitecture of hardware component 1 (display controller) and the commands of “Commands of Job K for HC2” being specific to the hardware and microarchitecture of hardware component 2 (video processing circuit). For example, the commands for the same task across the command buffers 210-230 can have different formats, the commands can have more or less commands for the same task, and the commands can have different opcodes due to the different microarchitectures of the corresponding processing circuits.

When executed by the host processing circuit, the scheduler also inserts a preceding predicate command such as “Predicate Command Addr(K)” corresponding to “Commands of Job K” and “Predicate Command Addr(K+1)” corresponding to “Commands of Job K+1.” When hardware component 2, such as a video processing circuit, reads command buffer 220 and executes “Predicate Command Addr(K)”, the video processing circuit checks the predicate memory location pointed to by the address “Addr(K).” The illustrated notation “Addr(K)” specifies an address pointing to the predicate memory location, which is a data storage location accessible by multiple processing circuits. In other words, the predicate memory location is a shareable memory location. If the encoding or metadata stored at this memory location indicates hardware component 3 (host processing circuit) or any other hardware component of the functionality group has begun execution of “Commands of Job K,” then the video processing circuit (hardware component 2) discards or otherwise invalidates each of “Predicate Command Addr(K)” and corresponding commands of “Commands of Job K” from command buffer 220.

Afterward, the video processing circuit (hardware component 2) next checks the memory location pointed to by the address “Addr(K+1)” based on the predicate command “Predicate Command Addr(K).” If the encoding or metadata stored at this memory location indicates no hardware component has begun execution of “Commands of Job K+1,” then the video processing circuit (hardware component 2) updates the encoding or metadata at this memory location pointed to by the address “Addr(K+1)” to specify that video processing circuit (hardware component 2) has begun executing the job “Commands of Job K+1.” Afterward, video processing circuit (hardware component 2) reads the command of “Commands of Job K+1.” Each of the hardware component 1 (display controller) and hardware component 3 (host processing circuit) performs similar steps. It is noted that in other implementations, the predicate commands, such as “Predicate Command Addr(K),” are included in the commands of the job, such as “Commands of Job K,” rather than being separate from or preceding the command of the job.

In some implementations, the computing system utilizes a mode of operation that determines whether to use the predicate commands and functionality groups when scheduling tasks across a variety of types of processing circuits. When the mode is enabled, the scheduler updates a table, such as table 160 (of FIG. 1), to form functionality groups, such as functionality groups 170-172 (of FIG. 1), and inserts predicate commands and commands translated from instructions to multiple command buffers of a functionality group such as command buffers 210-230. When the mode is disabled, the scheduler uses other scheduling mechanisms that do not utilize the functionality groups or predicate commands. Rather, the scheduler sends translated commands to a single command buffer corresponding to a single processing circuit based on the type of function, predicted performance, a priority level, or other criteria.

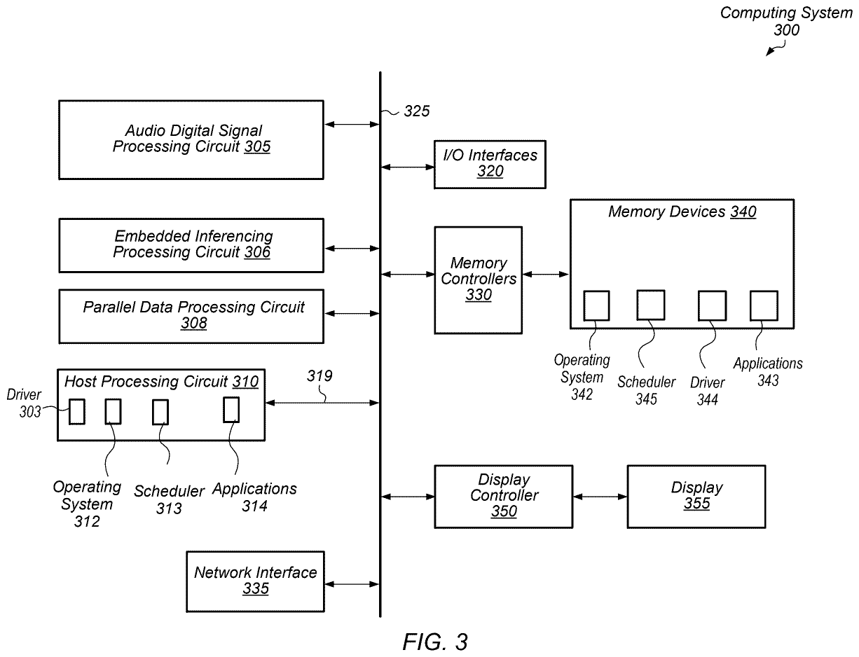

Turning now to FIG. 3, a generalized diagram is shown of a computing system 300 that performs efficient scheduling of tasks across a variety of processing circuits. In an implementation, computing system 300 includes at least processing circuits 305, 306, 308 and 310. Additionally, computing system 300 includes input/output (I/O) interfaces 320, bus 325, network interface 335, memory controllers 330, memory devices 340, display controller 350, and display device 355. In other implementations, computing system 300 includes other components and/or computing system 300 is arranged differently. For example, power management circuitry, and phased locked loops (PLLs) or other clock generating circuitry are not shown for ease of illustration. In various implementations, the components of the computing system 300 are on the same die such as a system-on-a-chip (SOC). In other implementations, the components are individual dies in a system-in-package (SiP) or a multi-chip module (MCM). A variety of computing devices use the computing system 300 such as a desktop computer, a laptop computer, a server computer, a tablet computer, a smartphone, a gaming device, a smartwatch, and so on.

In various implementations, host processing circuit 310 includes circuitry that executes instructions of a copy of the operating system 342 and commands from the operating system 342. Processing circuits 305, 306, 308 and 310 are representative of any number of processing circuits which are included in computing system 300. In an implementation, host processing circuit 310 is a general-purpose processing circuit, such as a central processing unit (CPU), and includes multiple general-purpose processor cores, each with one or more general-purpose pipelines that execute instructions of a particular instruction set architecture (ISA). A local memory (not shown) includes a local hierarchical cache memory subsystem of processing circuit 310. The local memory stores source data, intermediate results data, results data, and copies of data and instructions stored in memory devices 340. Examples are the operating system 312 (copy of at least a portion of operating system 342), driver 303 (copy of driver 344), task (or job) scheduler 313 (copy of scheduler 345), and applications 314 (copies of at least portions of applications 343).

Processing circuit 310 is coupled to bus 325 via interface 319. In an implementation, interface 319 uses the communication protocol of a peripheral component interconnect (PCI) bus, a PCI-Extended (PCI-X), or a PCIE (PCI Express) bus. In some implementations, processing circuit 310 has a direct point-to-point (P3P) connection with processing circuit 308 that bypasses bus 325. Processing circuit 310 receives, via interface 319, copies of various data and instructions, such as a host operating system 312, one or more device drivers, one or more applications such as application 314, and/or other data and instructions.

In various implementations, processing circuit 308 is a parallel data processing circuit with a highly parallel data microarchitecture. Examples of processing circuit 308 are a graphics processing unit (GPU), a digital signal processing circuit (DSP), a field programmable gate arrays (FPGA), an application specific integrated circuit (ASIC), and so forth. Processing circuit 308 can be a discrete device, such as a dedicated GPU (dGPU), or processing circuit 308 can be integrated in the same package as another processing circuit such as processing circuit 310. In such cases, processing circuit 308 is an integrated GPU (iGPU). In some implementations, processing circuit 306 is one of an embedded inference processing unit (EIPU) or an embedded inference processing circuit, an artificial intelligence (AI) accelerator processing circuit, an embedded neural processing unit (NPU) or an embedded neural processing circuit, a multiprocessing circuit, and so on. Processing circuit 306 executes a machine learning data model.

n various implementations, processing circuit 305 is an audio digital signal processor (DSP) or digital signal processing circuit. Processing circuit 305 receives a digital representation of analog audio information and performs mathematical operations on the received data to analyze, filter, identify, convert or perform another operation on the received data. In some implementations, host processing circuit 310 executes instructions of scheduler 313, which includes the functionality of user mode driver 126 (of FIG. 1) or another type of scheduler. In other implementations, another processing circuit executes a device driver that performs the scheduling steps described earlier for layering model 100 (of FIG. 1) and buffer 200 (of FIG. 2). In some implementations, the computing system 300 utilizes a mode of operation that determines whether to use the predicate commands and functionality groups when scheduling tasks across a variety of types of processing circuits such as at least processing circuits 305, 306, 308 and 310. When the mode is enabled, the scheduler 313 executed by host processing circuit 310 updates a table, such as table 160 (of FIG. 1), to form functionality groups, such as functionality groups 170-172 (of FIG. 1), and inserts predicate commands and commands translated from instructions to multiple command buffers of a functionality group such as command buffers 210-230 (of FIG. 2). When the mode is disabled, the scheduler 313 executed by processing circuit 310 uses other scheduling mechanisms that do not utilize the functionality groups or predicate commands. Rather, scheduler 313 sends translated commands to a single command buffer corresponding to a single processing circuit based on the type of function, predicted performance, a priority level, or other criteria.

In some implementations, computing system 300 utilizes a communication fabric (“fabric”), rather than the bus 325, for transferring requests, responses, and messages between the processing circuits 305 and 310, the I/O interfaces 320, the memory controllers 330, the network interface 335, and the display controller 350. When messages include requests for obtaining targeted data, the circuitry of interfaces within the components of computing system 300 translates target addresses of requested data. In some implementations, the bus 325, or a fabric, includes circuitry for supporting communication, data transmission, network protocols, address formats, interface signals and synchronous/asynchronous clock domain usage for routing data.

Memory controllers 330 are representative of any number and type of memory controllers accessible by processing circuits 305 and 310. While memory controllers 330 are shown as being separate from processing circuits 305 and 310, it should be understood that this merely represents one possible implementation. In other implementations, one of memory controllers 330 is embedded within one or more of processing circuits 305 and 310 or it is located on the same semiconductor die as one or more of processing circuits 305 and 310. Memory controllers 330 are coupled to any number and type of memory devices 340.

Memory devices 340 are representative of any number and type of memory devices. For example, the type of memory in memory devices 340 includes Dynamic Random Access Memory (DRAM), Static Random Access Memory (SRAM), NAND Flash memory, NOR flash memory, Ferroelectric Random Access Memory (FeRAM), or otherwise. Memory devices 340 store at least instructions of an operating system, one or more device drivers, and application. In some implementations, an application stored on memory devices 340 is a highly parallel data application such as a video graphics application, a shader application, or other. Copies of these instructions can be stored in a memory or cache device local to processing circuit 310 and/or processing circuit 305.

I/O interfaces 320 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 320. Such peripheral devices include (but are not limited to) displays, keyboards, mice, printers, scanners, joysticks or other types of game controllers, media recording devices, external storage devices, and so forth. Network interface 335 receives and sends network messages across a network.

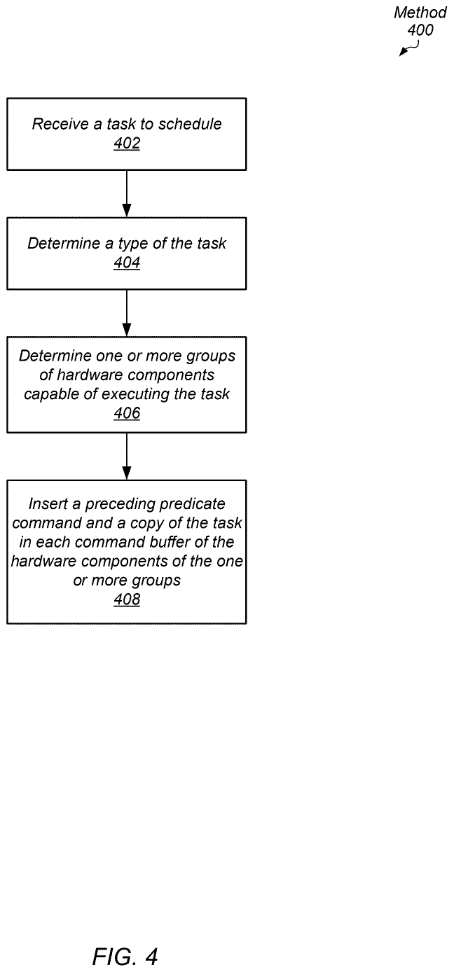

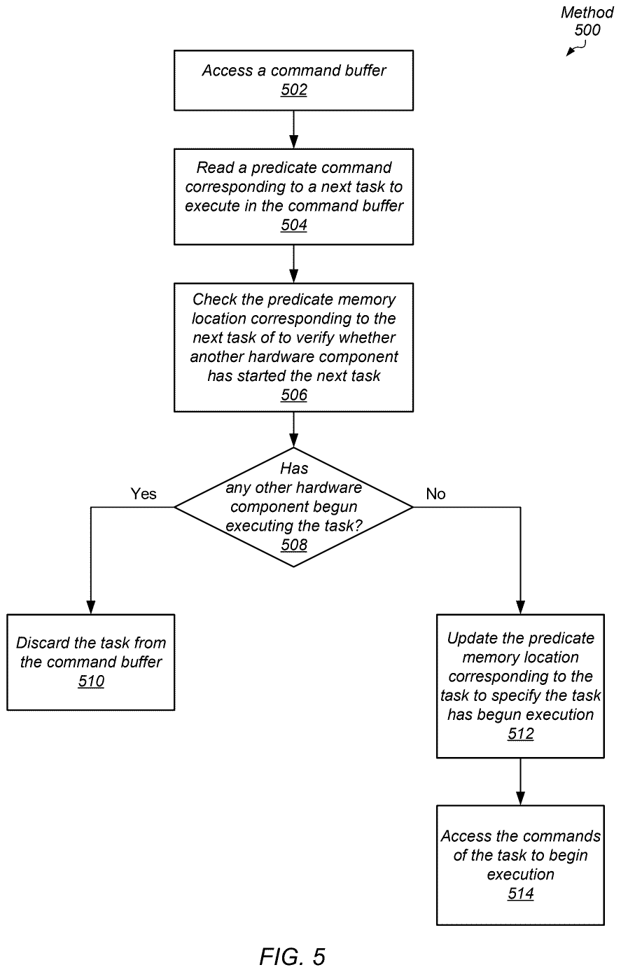

For methods 400-500, a computing system includes multiple processing circuits. Examples of the host processing circuit of the multiple processing circuits are host processing circuit 150 (of FIG. 1) and host processing circuit 310 (of FIG. 3). Examples of other types of processing circuits that can be grouped into one or more functionality groups are the processing circuits of hardware components 140 (of FIG. 1) and processing circuits 305, 306, 308 and 310 (of FIG. 3). Referring to FIG. 4, a generalized diagram is shown of a method 400 for efficiently scheduling of tasks across a variety of processing circuits. For purposes of discussion, the steps in this implementation (as well as in FIG. 5) are shown in sequential order. However, in other implementations some steps occur in a different order than shown, some steps are performed concurrently, some steps are combined with other steps, and some steps are absent.

A host processing circuit executes a user mode driver or other type of device driver or scheduler. In other implementations, another type of processing circuit executes the scheduler. For example, any one of the hardware components 140 (of FIG. 1) or processing circuits 305, 306, 308 and 310 of computing system 300 (of FIG. 3) executes the scheduler. The processing circuit receives a task to schedule (block 402). The processing circuit determines the type of the task (block 404). In various implementations, the task is a process or thread of a variety of types of applications. The type of task indicates a type of function to execute. The types of the task (or job or function) that can be executed by multiple processing circuits with different microarchitectures include video graphics color correction, data compression and decompression (codec), video graphics scaling, and so on.

The processing circuit determines one or more groups of hardware components capable of executing the task (block 406). In an implementation, the processing circuit accesses a table, such as table 160 (of FIG. 1), that maps types of functions to functionality groups. As described earlier, a “functionality group” includes two or more processing circuits with each processing circuit capable of executing a particular function and with at least one processing circuit using a different microarchitecture from other processing circuits of the two or more processing circuits in the same functionality group. In various implementations, the host processing circuit obtains available features of the hardware components during a discovery stage of a boot process or operation of the computing system. When executing the user mode driver or another scheduler, the host processing circuit receives indications, based on the boot operation or process, specifying available features provided by the hardware components.

Additionally, when peripheral devices are added, such as an additional display device with a display controller or an on-board display controller becomes active due to the connection, the available features of the hardware components are updated. Based on these indications, the scheduler can form functionality groups, such as functionality groups 170 and 172 (of FIG. 1), of hardware components that can execute the same job. The scheduler can also update table 160 (of FIG. 1). For example, each of a field programmable gate array (FPGA), such as accelerator circuit 156 (of FIG. 1), a graphics processing unit (GPU) or graphics processing circuit, such as parallel data processing circuit 152 (of FIG. 1), and neural processing unit (NPU) or neural processing circuit 158 (of FIG. 1) can perform inference by executing processes of machine learning (ML) stages or layers of a trained ML model and each processing circuit uses a different microarchitecture. The scheduler updates the table to map the inferencing ML layer functions with these types of processing circuits in a functionality group. In another example, each of a display controller, a video processing circuit and a host processing circuit includes hardware and a microarchitecture capable of executing a color correction task and each processing circuit uses a different microarchitecture. The scheduler updates the table to map the color correction function with these types of processing circuits in a functionality group.

The processing circuit inserts a preceding predicate command and a copy of the task in each command buffer of the hardware components of the one or more groups (block 408). Typically, a computing system schedules the task to a single one of the processing circuits based on the type of function, predicted performance, or other criteria. However, such scheduling to a single processing circuit can cause a delay in starting the task while other processing circuits capable of executing the task become available. In contrast, the proposed processing circuit schedules the task to multiple processing circuits, rather than a single processing circuit. These processing circuits are grouped into a corresponding functionality group.

In some implementations, the computing system utilizes a mode of operation that determines whether to use the predicate commands and functionality groups when scheduling tasks across a variety of types of processing circuits. When the mode is enabled, the scheduler updates a table, such as table 160 (of FIG. 1), to form functionality groups, such as functionality groups 170-172 (of FIG. 1), and inserts predicate commands and commands translated from instructions to multiple command buffers of a functionality group such as command buffers 210-230 (of FIG. 2). When the mode is disabled, the scheduler uses other scheduling mechanisms that do not utilize the functionality groups or predicate commands. Rather, the scheduler sends translated commands to a single command buffer corresponding to a single processing circuit based on the type of function, predicted performance, a priority level, or other criteria.

Referring to FIG. 5, a generalized diagram is shown of a method 500 for efficiently scheduling tasks across a variety of processing circuits. A hardware component, such as a processing circuit, accesses a command buffer (block 502). For example, any one of the hardware components 140 (of FIG. 1) or processing circuits 305, 306, 308 and 310 of computing system 300 (of FIG. 3) accesses a corresponding command buffer. The processing circuit reads a predicate command corresponding to the next task to execute in the command buffer (block 504). The processing circuit checks the predicate memory location corresponding to the next task to verify whether another hardware component has started the next task (block 506). If any other hardware component has begun executing the task (“yes” branch of the conditional block 508), then the processing circuit discards the task from the command buffer (block 510). Otherwise, if no other hardware component has begun executing the task (“no” branch of the conditional block 508), then the processing circuit updates the predicate memory location corresponding to the task to specify the task has begun execution (block 512). The processing circuit accesses the commands of the task to begin execution (block 514).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
circuitry configured to:
access a command buffer configured to store a first task, wherein one or more copies of the first task are stored in a plurality of command buffers corresponding to a plurality of processing circuits;
retrieve a first address from the command buffer;
access a first memory location pointed to by the first address; and
discard the first task from the command buffer, responsive to data stored at the first memory location indicating another processing circuit of the plurality of processing circuits has begun execution of the first task.

2. The apparatus as recited in claim 1, wherein at least one of the one or more copies of the first task comprises commands different from commands used in another copy of the one or more copies of the first task.

3. The apparatus as recited in claim 2, wherein at least one of the plurality of processing circuits has a different microarchitecture from a microarchitecture of another processing circuit of the plurality of processing circuits.

4. The apparatus as recited in claim 1, wherein the circuitry is configured to retrieve a second address from the command buffer corresponding to a second task, wherein one or more copies of the second task are stored in the plurality of command buffers corresponding to the plurality of processing circuits.

5. The apparatus as recited in claim 4, wherein the circuitry is configured to:
access a second memory location pointed to by the second address; and
update data stored at the second memory location to indicate the second task has begun execution, responsive to the data indicating no processing circuit of the plurality of processing circuits has begun executing the second task.

6. The apparatus as recited in claim 4, wherein one or more of the first task and the second task is directed to one or more of video data processing and machine learning model processing.

7. The apparatus as recited in claim 1, wherein, based on functionalities of the plurality of processing circuits discovered during a boot operation, the plurality of processing circuits are placed in a functionality group configured to execute one or more tasks of a same type.

8. A method, comprising:
accessing, by a processing circuit of a plurality of processing circuits, a command buffer of a plurality of command buffers configured to store a first task, wherein one or more copies of the first task are stored in the plurality of command buffers corresponding to the plurality of processing circuits;
retrieving, by the processing circuit, a first address from the command buffer;
accessing, by the processing circuit, a first memory location pointed to by the first address; and
discarding, by the processing circuit, the first task from the command buffer, responsive to data stored at the first memory location indicating another processing circuit of the plurality of processing circuits has begun execution of the first task.

9. The method as recited in claim 8, wherein at least one of the one or more copies of the first task comprises commands different from commands used in another copy of the one or more copies of the first task.

10. The method as recited in claim 9, wherein at least one of the plurality of processing circuits has a different microarchitecture from a microarchitecture of another processing circuit of the plurality of processing circuits.

11. The method as recited in claim 8, further comprising retrieving, by the processing circuit, a second address from the command buffer corresponding to a second task, wherein one or more copies of the second task are stored in the plurality of command buffers corresponding to the plurality of processing circuits.

12. The method as recited in claim 11, further comprising:
accessing, by the processing circuit, a second memory location pointed to by the second address; and
updating, by the processing circuit, data stored at the second memory location to specify the second task has begun execution, responsive to the data indicating no processing circuit of the plurality of processing circuits has begun executing the second task.

13. The method as recited in claim 11, wherein one or more of the first task and the second task is directed to one or more of video data processing and machine learning model processing.

14. The method as recited in claim 8, wherein, based on functionalities of the plurality of processing circuits discovered during a boot operation, the plurality of processing circuits are placed in a functionality group configured to execute one or more tasks of a same type.

15. A computing system comprising:
a plurality of processing circuits; and
scheduling circuitry configured to:
generate a plurality of command buffers, each of the command buffers corresponding to a different processing circuit of the plurality of processing circuits that have been identified as being capable of executing a given task; and
store one or more commands corresponding to the given task in each of the plurality of command buffers; and
wherein each of the plurality of computing circuits is configured to access a location in memory to determine whether it is to execute the one or more commands.

16. The computing system as recited in claim 15, wherein the location in memory is identified by data stored in a command buffer of the plurality of command buffers.

17. The computing system as recited in claim 15, wherein a processing circuit of the plurality of processing circuits is configured to discard the given task from a corresponding one of the plurality of command buffers, responsive to data stored at the location in memory specifies another one of the plurality of processing circuits has begun execution of the given task.

18. The computing system as recited in claim 17, wherein at least one of one or more copies of the given task stored in the plurality of command buffers comprises commands different from commands stored in another one of the plurality of command buffers.

19. The computing system as recited in claim 18, wherein at least one of the plurality of processing circuits has a different microarchitecture from a microarchitecture of another processing circuit of the plurality of processing circuits.

20. The computing system as recited in claim 15, wherein a processing circuit of the plurality of processing circuits is configured to update data stored at the location in memory to specify the given task has begun execution, responsive to the data specifies no processing circuit of the plurality of processing circuits has begun executing the given task.
